(19) United States
(12) Patent Application Publication
(10) Pub. No.: US 2010/0082647 A1
(43) Pub. Date: Apr. 1, 2010

(54) METHOD FOR CREATING IMAGE FILE AND METHOD FOR SORTING FILE SYSTEMS

(75) Inventor: Pin-Shiun Chen, Kaohsiung City (TW)

Correspondence Address: J C PATENTS, 4 VENTURE, SUITE 250, IRVINE, CA, 92618, US

(73) Assignee: Inventec Corporation, Taipei City (TW)

(21) Appl. No.: 12/512,894

(22) Filed: Jul. 30, 2009

(30) Foreign Application Priority Data
Sep. 30, 2008 (TW) 97137599

(51) Int. Cl. G06F 17/30

(52) U.S. Cl. 707/752; 707/E17.005; 707/E17.009

(57) ABSTRACT

A method for creating an image file and a method for sorting file systems are disclosed. First, a plurality of file systems is accessed respectively so as to create a plurality of access messages. Next, the access messages are sorted by using a sorting algorithm. Finally, the locations in an image file of the file systems are determined according to the orders arranged by the access messages so as to compress the file systems into the image file.

### CROSS-REFERENCE TO RELATED APPLICATION

This application claims the priority benefit of Taiwan application serial no. 97137599, filed Sep. 30, 2008. The entirety of the above-mentioned patent application is hereby incorporated by reference herein and made a part of specification.

### BACKGROUND OF THE INVENTION

1. Field of the Invention

The present invention generally relates to a creating method of a live compact disk (live CD), and more particularly, to a method for creating an image file and a method for sorting file systems.

2. Description of Related Art

In general, a live CD stands for an operation system (OS) which can be executed without being installed onto a hard disk. A live CD is read by an optical disk drive (ODD) so as to start a computer directly by the live CD. Once the live CD is started, an image file stored in the live CD would be decompressed and the decompressed file is written into the random access memory disk (RAM disk) inside the computer so as to establish an executable environment in the RAM disk. In this way, by means of a live CD, an OS is exempted to be installed in a hard disk, which gains advantages of exempting installation and saving the successive maintenance job.

Although a live CD can be easily created and used for pre-stage testing; however, considering an inherent physical limit for the storage medium of optical disk to cyclically reading operations, the live CD exhibits a disadvantage of slow speed no matter as staring the computer or executing programs, which degrades the system performance, causes poor utilization efficiency and produces unnecessary consumes of an ODD and an optical disk.

### SUMMARY OF THE INVENTION

Accordingly, the present invention is directed to a method for creating an image file, by which a plurality of file systems is sorted in advance, followed by being compressed into an image file.

The present invention is also directed to a method for sorting file systems, by which the file systems are sorted according to the access order and the counting number of access of each of the file systems.

The present invention provides a method for creating an image file. First, a plurality of file systems is accessed respectively so as to create a plurality of access messages. Next, the access messages are stored into a log file. Then, the log file is read out so that the access messages are sorted according to a sorting algorithm. Finally, the locations of the file systems in the image file are decided according to the orders of the access messages so as to compress the file systems into an image file.

In an embodiment of the present invention, the above-mentioned step of storing the access messages into a log file includes sequentially storing the access messages in advance according to the orders of accessing the file systems. After that, the access messages are re-sorted according to the counting number of accessing each of the file systems.

In an embodiment of the present invention, the above-mentioned step of sorting the access messages according to the counting number of accessing each of the file systems includes dividing the log file into a plurality of comparison ranges, and then, assigning a weight to the access message taking the frontmost order in each of the comparison ranges and deleting the rest access messages taking the orders after the above-mentioned frontmost order if a plurality of access messages belongs to a same file system in each the comparison range. After assigning the weights, in each of the comparison ranges, when a plurality of access messages still belongs to a same file system, only the access message with the highest weight is reserved and the rest access messages belonging to the above-mentioned same file system are deleted, which creates a sorting list so as to compress the file systems into an image file according to the sorting list.

In an embodiment of the present invention, the above-mentioned method for creating an image file further includes enlarging a buffer area for storing the log file and storing the access messages into the log file by using a kernel logger.

In an embodiment of the present invention, prior to the step of storing the access messages into the log file, the above-mentioned method for creating an image file further includes reading a live CD so as to decompress the kernel logger and the file systems of the live CD and write the decompressed ones into a RAM disk.

In an embodiment of the present invention, the above-mentioned image file can be compressed by using a compressed read-only file system.

In an embodiment of the present invention, the above-mentioned step of accessing the file systems includes only accessing the file systems required for starting the computer.

In addition, the present invention provides a method for sorting file systems. First, a plurality of access messages is stored according to the access orders of a plurality of file systems, wherein when a file system is accessed, a access message is correspondingly created. Next, a weight is assigned to each of the access messages according to the counting number of accessing each of the file systems. Finally, the orders of the access messages are adjusted according to the weight of each of the access messages.

In an embodiment of the present invention, the above-mentioned step of assigning a weight to each of the access messages includes, first, dividing the access messages into a plurality of comparison ranges, wherein when at least two access messages in each comparison range belong to a same file system, the access message taking the frontmost order in each of the comparison ranges is assigned with a weight and the rest access messages taking the following orders are deleted. Next, the above-mentioned step of adjusting the orders of the access messages according to the weight of each of the access messages includes that after respectively assigning a weight to each of the access messages, if still at least two access messages belong to a same file system, only the access message with the highest weight is reserved and the rest access messages are deleted.

The present invention takes a scheme to sort the file systems according to the access order and the counting number of access for each of the file systems. After that, the orders after the sorting are used to compress the file systems into an image file and write by burning the image file into an optical disk, which is advantageous in reducing the moving distance of the disk read-and-write head in an ODD and effectively reducing the time for starting the computer and executing programs.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a method for creating an image file according to an embodiment of the present invention.

FIG. 2 is a flowchart of a method for sorting file systems according to an embodiment of the present invention.

FIG. 3A-3D are diagrams showing the access messages according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts. For simplicity of depiction, the following embodiments are based on, for example, an implementation platform of Linux system. However, other embodiments can be applied in an OS other than Linux.

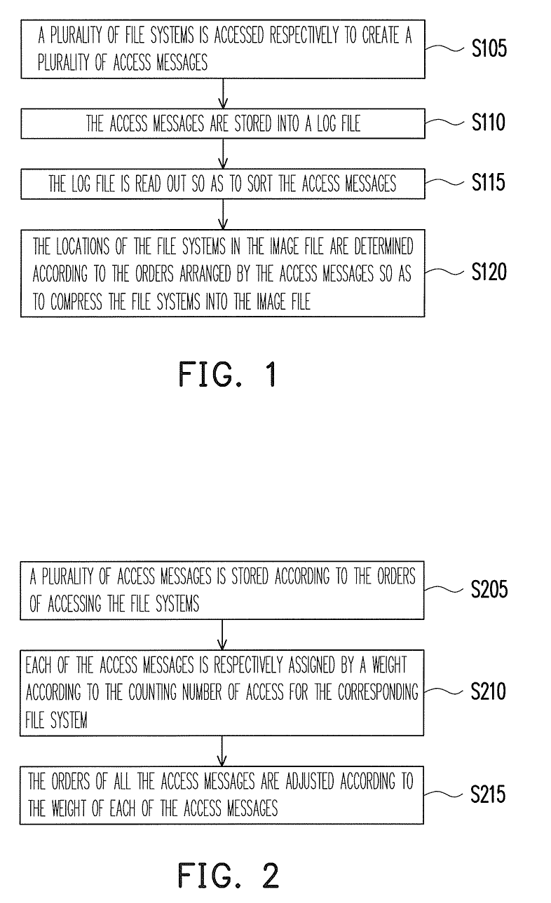

FIG. 1 is a flowchart of a method for creating an image file according to an embodiment of the present invention. Referring to FIG. 1, first in step S105, a plurality of file systems is accessed respectively to create a plurality of access messages. In terms of an OS, the file systems provide a user with a function of accessing data and programs.

In the embodiment, the file systems are obtained by using an ODD to read a present live CD so that a kernel logger and the file systems both in the live CD are decompressed and then written into a RAM disk. After that, the kernel logger is used to analyze the file systems. That is, the file systems are accessed through the kernel logger, wherein maybe the file systems required for starting the computer are accessed.

Next in step S110, the access messages are stored into a log file by using the kernel logger; that is, the kernel logger would be modified so that the above-mentioned access message is recorded into the log file through the kernel logger after each of the file systems is accessed. For example, whenever a file system is read, the access message is recorded into the log file by using the printk function. In this way, the list and the orders of all the accessed file systems can be reserved.

In the embodiment, the buffer area can be enlarged in advance to ensure completely storing the log file.

Then in step S115, the log file is read out so as to sort the access messages by using a sorting algorithm. For example, the access messages can be sorted according to the orders of the file systems, and then the access messages are re-sorted according to the counting number of access for each of the file systems. In other words, the file system accessed at the earliest is arranged in the frontmost order. In addition, the file systems more often accessed are arranged nearby.

Finally in step S120, the locations of the file systems in the image file are determined according to the orders arranged by the access messages so as to compress the file systems into the image file. For example, a compressed read-only file system (for example SquashFS) is used to compress the file systems into the image file. It should be noted that the relative locations of the file systems in a CD are recorded in the image file, so that the file systems are written by burning into the CD according to the arrangement orders thereof.

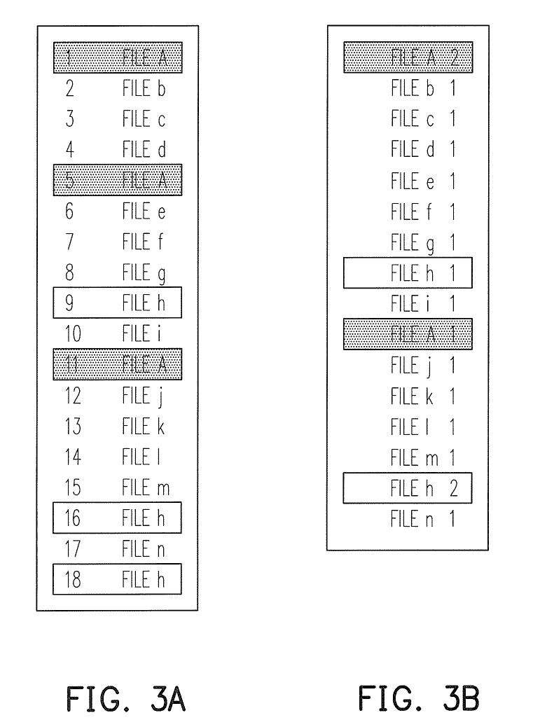

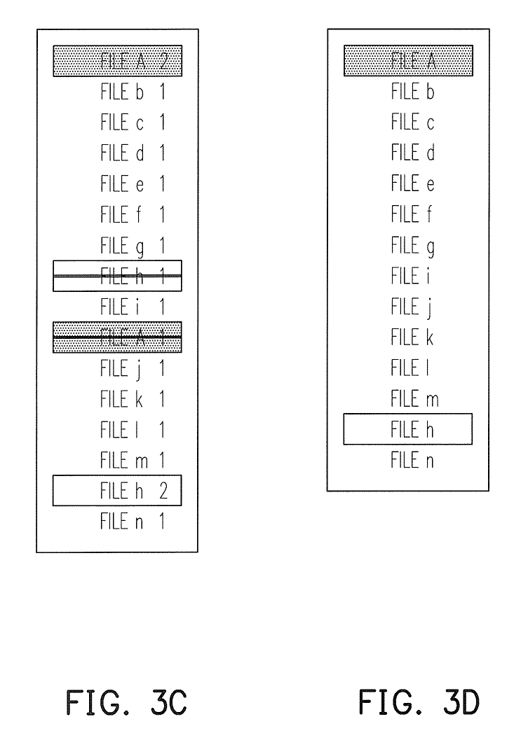

Another embodiment is described as follows to explain the method for sorting file systems in detail. FIG. 2 is a flowchart of a method for sorting file systems according to an embodiment of the present invention and FIG. 3A-3D are diagrams showing the access messages according to an embodiment of the present invention.

Referring to FIG. 2, first in step S205, a plurality of access messages (as shown in FIG. 3A) is stored according to the orders of accessing the file systems. Whenever a file system is accessed, a corresponding access message is created, followed by sequentially storing the access message by using a kernel logger.

Next in step S210, each of the access messages is respectively assigned by a weight according to the counting number of access for the corresponding file system. In more detail, the access messages are divided into a plurality of comparison range first. In each of the comparison range, when at least two access messages belong to a same file system, a weight is assigned to the access message taking the frontmost order and the rest access messages taking the following orders are deleted.

Referring to FIGS. 3A and 3B, a threshold value of 5 is preset and all the access messages are divided into four comparison ranges, wherein five access messages comprise a unit. As shown in FIG. 3A, in the comparison range comprising ones from the first comparison range to the fifth comparison range, both the first access message and the fifth access message belong to ‘FILE A’, which means the difference therebetween is less than the threshold value of 5. Accordingly as shown by FIG. 3B, a weight of ‘2’ is assigned to the first access message and the fifth access message is deleted.

Continuing to FIG. 3A, since the difference between the eleventh access message and the first access message is greater than the threshold value of 5, and there is no stored access message belonging to ‘FILE A’ in the comparison range comprising ones from the eleventh comparison range to the fifteenth comparison range, so that, as shown by FIG. 3B, a weight of ‘1’ is assigned to the eleventh access message. Analogically for the rest, a weight is respectively assigned to each of all the access messages.

Finally in step S215, as shown in FIG. 2, the orders of all the access messages are adjusted according to the weight of each of the access messages. In more detail, after the access messages are respectively assigned by a weight, if at least two access messages belong to a same file system, the access message taking the highest weight is remained and the rest access messages are deleted.

In FIG. 3C, both ‘FILE A’ and ‘FILE h’ respectively have two access messages. The weight of ‘2’ of ‘FILE A’ taking a more front order is greater than the weight of ‘1’ of ‘FILE A’ taking a back order. Therefore, ‘FILE A’ taking a front order is remained and ‘FILE A’ taking a back order is deleted. In addition, the weight of ‘1’ for ‘FILE h’ in the front order is less than the weight of ‘2’ for ‘FILE h’ in the back order, so that ‘file h’ in the back order is remained and ‘FILE h’ in the front order is deleted. After that, an order list as shown by FIG. 3D is created.

The methods of the above-mentioned embodiments can be implemented by a computer program serving as a software product. The software includes all the implementation features of the methods with the functions thereof described hereinbefore. Whenever the software is loaded in a computer system, the methods with the functions thereof provided by the present invention would be executed.

In summary, in the above-mentioned, after sorting the file systems in advance, the file systems are compressed into a image file and the image file is written by burning into a CD, so that the moving distance of the disk read-and-write head of an ODD can be thereby reduced and the time to start a computer and execute programs can be effectively reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for creating an image file, comprising:
accessing a plurality of file systems respectively to create a plurality of access messages;
storing the access messages into a log file;
reading out the log file and sorting the access messages by using a sorting algorithm; and
determining the locations of the file systems in the image file according to the orders arranged by the access messages so as to compress the file systems into the image file.

2. The method for creating an image file according to claim 1, wherein the step of storing the access messages into the log file further comprises:
storing the access messages according to the orders of accessing the file systems.

3. The method for creating an image file according to claim 1, wherein the step of sorting the access messages by using a sorting algorithm comprises:
sorting the access messages according to the counting number of accessing the file systems.

4. The method for creating an image file according to claim 3, wherein the step of sorting the access messages according to the counting number of accessing the file systems comprises:
dividing the log file into a plurality of comparison ranges;
in each of the comparison ranges, assigning a weight to the access message taking the frontmost order and deleting the rest access messages taking the following orders if at least two access messages among the access messages belong to a same file system; and
after respectively assigning a weight to each of the access messages, when at least two access messages among the access messages belong to a same file system, only the access message with the highest weight is reserved and the rest access messages belonging to the above-mentioned same file system are deleted, which creates a sorting list so as to compress the file systems into an image file according to the sorting list.

5. The method for creating an image file according to claim 1, further comprising:
enlarging a buffer area for storing the log file.

6. The method for creating an image file according to claim 1, wherein the step of storing the access messages into the log file comprises:
storing the access messages into the log file by using a kernel logger.

7. The method for creating an image file according to claim 1, wherein prior to the step of storing the access messages into the log file, the method for creating an image file further comprises:
reading a live CD so as to decompress the kernel logger and the file systems of the live CD and write the decompressed ones into a random access memory disk.

8. The method for creating an image file according to claim 1, wherein the step of compressing the file systems into the image file comprises:
using a compressed read-only file system to compress the file systems into the image file.

9. The method for creating an image file according to claim 1, wherein the step of accessing the file systems comprises:
only accessing the file systems required for starting the computer.

10. A method for sorting file systems, comprising:
storing a plurality of access messages according to the access orders of a plurality of file systems, wherein when the file systems are accessed, the access messages are created;
respectively assigning a weight to each of the access messages according to the counting number of accessing each of the file systems; and
adjusting the orders of the access messages according to the weight of each of the access messages.

11. The method for sorting file systems according to claim 10, wherein the step of respectively assigning the weight to each of the access messages comprises:
dividing the access messages into a plurality of comparison ranges; and
in each of the comparison ranges, assigning the weight to the access message taking the frontmost order and deleting the rest access messages taking the following orders if at least two access messages among the access messages belong to a same file system.

12. The method for sorting file systems according to claim 10, wherein the step of adjusting the orders of the access messages according to the weight of each of the access messages comprises:
after respectively assigning the weight to each of the access messages, when at least two access messages among the access messages belong to a same file system, the access message taking the frontmost order is reserved and the rest access messages are deleted.

13. The method for sorting file systems according to claim 10, wherein the step of storing the access messages comprises:
storing the access messages by using a kernel logger.

14. The method for sorting file systems according to claim 10, wherein when the file systems are accessed comprises:
only accessing the file systems required for starting the computer.

15. A computer program serving as a software product, which performs the method for creating an image file according to claim 1 after a computer loads the computer program therein.
